(19) United States
(12) Patent Application Publication
(10) Pub. No.: US 2010/0201153 A1
(43) Pub. Date: Aug. 12, 2010

(54) AIR DRAG REDUCTION SYSTEM

(76) Inventor: Ronald D. Pesotini, JR., Pittston Twp., PA (US)

Correspondence Address: Charles L. Riddle, Esq., 434 Lackawanna Ave, Suite 200, Scranton, PA, 18503, US

(21) Appl. No.: 12/367,530

(22) Filed: Feb. 8, 2009

(51) Int. Cl. B62D 35/00

(52) U.S. Cl. 296/180.4

(57) ABSTRACT

A drag reduction system [1000] is described for large vehicles [100] and trailers. The device includes an air deflector [1100] which is mounted on a hinged attachment piece [1200] near the rear section [130] of the vehicle [100]. The hinged attachment piece [1200] allows the air deflector [1100] to extend past a rear section [130] of the vehicle [100] deflecting an air stream at an angle behind the vehicle [100]. The air deflector [1100] is allowed to pivot such that it does not extend past the rear section [130] of the vehicle [100] allowing the vehicle to back up to a loading dock. A second embodiment includes a leading arm [1500] and a trailing arm [1600] pivotally connected to the air deflector. The air deflector [1100] is allowed to translate forward and out of the way allowing the vehicle [100] to mate with a standard loading dock.

### FEDERAL SPONSORED RESEARCH

Not applicable.

### SEQUENCE LISTING OR PROGRAM

Not applicable.

### CROSS REFERENCE TO RELATED APPLICATIONS

Not applicable.

### BACKGROUND OF THE INVENTION

1. Field of the Invention

The present invention relates to a system for reducing air drag on vehicles and more specifically a device that reduces air drag on vehicles leading to improved fuel economy.

2. Discussion of Related Art

As energy costs rise, it is important to increase fuel economy of land vehicles. The problem becomes most acute with larger vehicles, such as busses, recreational vehicles and trucks. If one were to increase the fuel economy of these vehicles, there would be a large cost savings and benefit. If wasted energy can be eliminated, the fuel economy will rise.

One source of wasted energy is a partial vacuum created behind trucks. Wind passing along the side of a moving truck passes around the back side of the truck. The area just behind the truck experiences a partial vacuum. If one were to reduce this vacuum, fuel economy will increase.

There have been attempts to reduce this vacuum with the aid of vane connected to the vehicle with several pliant attachment means as described in U.S. Pat. No. 7,240,958 B2 Skopic issued Jul. 10, 2007. Since the trucks are designed to back up to a loading dock and fit flush against a docking seal, there can be no equipment extending past the rear edge of the truck interfering with the seal. This is why the Skopic device is attached to the doors. The Skopic device is designed to be used on trucks having two rear doors which open from the center. These are called “barn-type doors”. As the barn-type doors open, they swing outward and forward parallel to the sides of the truck. In doing so, they fold the vane and pliant attachment means between the barn doors and the sides of the truck.

Due to their design, these cannot fold up out of the way with other types of doors, such as roll-up doors, or other doors besides barn-type doors. The flexible attachment means also becomes awkward and difficult to use.

Currently, there is a need for a drag reduction device which allows use on loading docks and is compatible with door styles other than barn-type doors.

### SUMMARY OF THE INVENTION

One embodiment of the present invention is a drag reduction system [1000] for increasing the fuel efficiency of a vehicle [100] having a rear section [130], at least one generally planar surface [110], and an air stream passing along the rear section [130], comprising:
a) an air deflector [1100] at least partially extending past said rear section [130] of said vehicle [100] for deflecting said air stream at an angle behind said vehicle [100],
b) a hinged attachment piece [1200] connected to said vehicle [100] and to said air deflector [1100] allowing the air deflector to pivot to a first position extending past said rear section [130] of said vehicle [100] in which it deflects said air stream behind the vehicle [100], and a second position in which the air deflector [1100] and hinged attachment piece [1200] pivot forward and do not extend beyond an end of said rear section [130] of said vehicle [100] allowing said vehicle [100] to fit against a standard loading dock.

The present invention may also be embodied as a method of reducing air drag and increasing fuel economy of a moving vehicle [100] having a rear section [130] which is compatible with existing loading docks, comprising the steps of:
a) pivotally securing an air deflector [1100] to extend from the rear of said vehicle [100] in a first position angled to direct said air stream to a location behind said vehicle [100] when said vehicle is being driven; and
b) pivoting the air deflectors [1100] to a second position so that they do not extend beyond the rear section [130] of said vehicle [100] when being docked to allow said vehicle rear section [130] to mate with a conventional loading dock.

### OBJECTS OF THE INVENTION

It is an object of the present invention to provide a device which reduces wind drag which retrofits existing vehicles increasing fuel economy.

It is another object of the present invention to provide a device which reduces wind drag which retrofits existing vehicles having roll-up rear doors increasing fuel economy.

It is an object of the present invention to provide a device which reduces wind drag for vehicles increasing fuel economy.

It is another object of the present invention to provide a device which reduces wind drag for new vehicles having roll-up rear doors increasing fuel economy.

It is another object of the present invention to provide a device which reduces wind drag that fold back to allow mating of the vehicle with an existing loading dock.

It is another object of the present invention to provide a drag reduction system which is compatible with loading docks.

It is another object of the present invention to provide a method of reducing wind drag for vehicles with roll-up doors while still allowing the vehicle to use existing loading docks.

### BRIEF DESCRIPTION OF THE DRAWINGS

The advantages of the instant disclosure will become more apparent when read with the specification and the drawings, wherein:

FIG. 1 is a perspective view of one embodiment of the drag reduction system 1000 according to the present invention as it would appear installed on a truck trailer 100.

FIG. 2 is a rear elevational view of the drag reduction system 1000 of FIG. 1.

FIG. 3 is a side elevational view of the drag reduction system 1000 of FIGS. 1 and 2.

FIG. 4 is an enlarged partial top view along lines “IV”-“IV” of the rear section 130 of the truck trailer 100.

FIG. 5 is an enlarged cross sectional view through lines “V”-“V” of FIG. 3 of the rear section 130 of the truck trailer.

FIG. 6 is an enlarged cross sectional view of a portion of the present invention 1000 attached to the rear section 130 showing both the working and the unloading positions of the present invention.

FIG. 7 is a partial elevational view from between the vehicle and air deflector showing the flexible snap clip according to the present invention.

FIG. 8 is a partial perspective view of one embodiment of the drag reduction system 1000 according to the present invention as it would appear installed on a delivery truck 100.

FIG. 9 is an enlarged cross sectional view of an alternative embodiment of the present invention in its driving position.

FIG. 10 is an enlarged cross sectional view of an alternative embodiment of the present invention in its unloading position.

### DETAILED DESCRIPTION OF THE INVENTION

Since vehicles, such as trailer trucks, busses, and recreational vehicles, are very large and not very streamlined, they create significant air drag.

These vehicles typically have flat rear sections. As they move at highway speeds, turbulence forms behind the vehicles causing a partial vacuum. This partial vacuum creates drag on the vehicle reducing gas mileage.

Since they are typically driven many miles each year, a small increase in fuel mileage results in a significant cost savings.

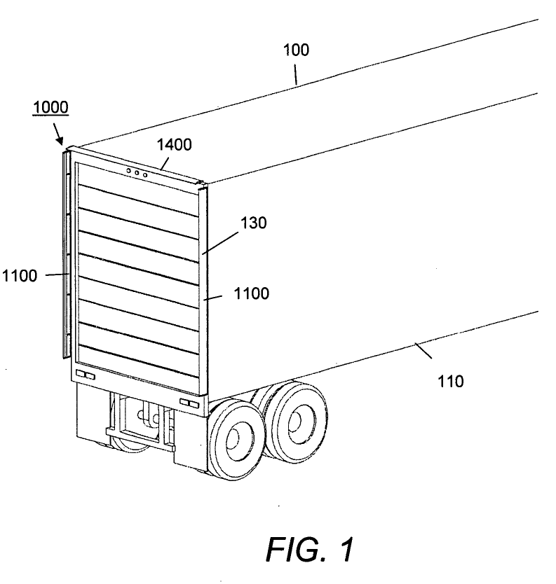

FIG. 1 is a partial perspective view of one embodiment of the drag reduction system 1000 according to the present invention as it would appear installed on a truck trailer 100.

Air deflectors 1100 here are attached to the sides 110 of the trailer 100 near the rear section 130.

These air deflectors 1100 angle air streams passing along the sides 110 of trailer 100 toward a midline of the trailer 100 behind the trailer 100. This reduces the partial vacuum behind the vehicle and increases fuel economy.

To become more efficient, they would have to extend past the rear of vehicle 100. Trailers 100 are typically backed up to loading docks for loading/unloading. The rear section 130 is pressed against padding on the loading dock to create an air seal between the trailer 100 and the loading dock. This allows the trailer to be loaded/unloaded from a loading dock which is shielded from the weather. Therefore, there should be no obstructions extending from the rear of the trailer 100 to interfere with the mating of the truck rear section 130 with the loading dock seal.

Depending upon the shape of the trailer, it may also be beneficial to add top deflector 1400 on the top surface near the rear of trailer 100.

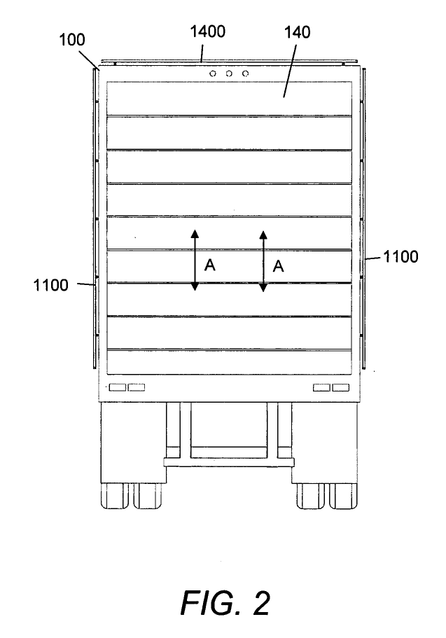

FIG. 2 is a rear elevational view of the drag reduction system 1000 of FIG. 1. Please note that the drag reduction system 1000 is attached to the vehicle 100 and not the doors or gates as in prior art designs. The type shown in FIGS. 1, 2, 3, and 8 are roll-up doors 140 which roll up or down in the direction of the arrows marked “A”.

The doors on other trailers are typically barn-type doors. These are dual doors which meet at the center and open outward and swing to fit flush against the sides 110 of the trailer. The prior art air deflection systems, such as that of Skopic, rely upon this geometry to fold the air deflection apparatus away from the rear of the trailers. These types of air deflection systems would not function, or not function well, with these roll-up type doors shown in the figures.

As is obvious here, the present invention does not rely upon barn-doors to fold it back and out of the way. The present invention is designed to attach to a fixed portion of the vehicle, and is designed to fold by itself.

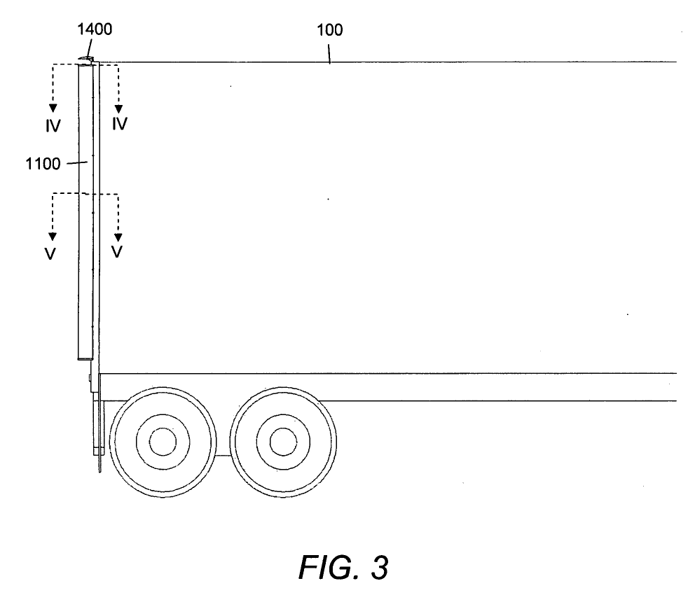

FIG. 3 is a side elevational view of the drag reduction system 1000 of FIGS. 1 and 2. Here it can be seen how air deflectors 1100 extend past the rear of trailer 100.

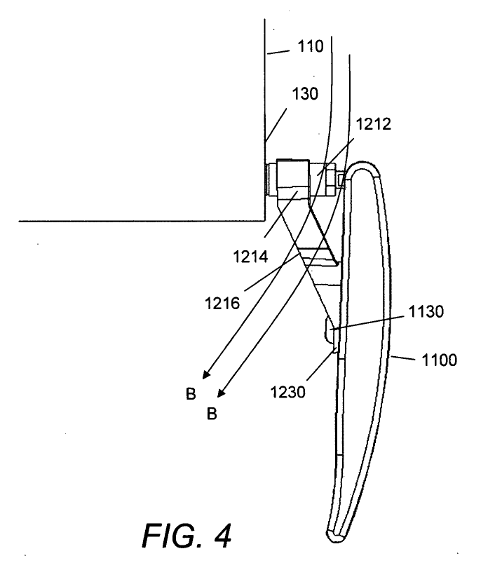

FIG. 4 is an enlarged partial top view along lines “IV”-“IV” of the rear section 130 of the truck trailer 100. One side of the drag reduction system 1000 is shown here.

A plurality of anchor pieces 1212 attach to the rear section 130 of vehicle 100 along the side 110.

The top section of anchor pieces 1212 employ a hinge (not shown in this view) allowing air deflector 1100 to pivot with respect to the anchor piece 1212 and side 110.

An angled arm 1216 has a deflector mount 1230 which attaches to the air deflector 1100.

Angled arm 1216 has a flexible snap clip 1214 which is designed to snap on and off of anchor piece 1212. When snapped onto anchor piece 1212, air deflector 1100 is held in the position shown here. This is the working position. Here it can be seen that air streams are diverted following the path according to arrows marked “B”.

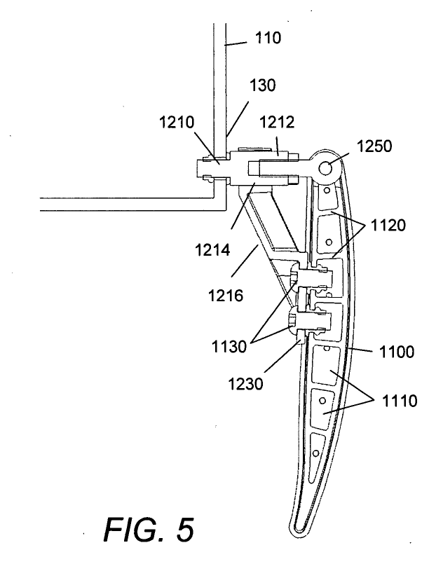

FIG. 5 is an enlarged cross sectional view of the drag reduction system 1000 through lines “V”-“V” of FIG. 3 of the rear section 130 of the truck trailer 100.

In this embodiment, anchor piece 1212 is shown having a vehicle mount 1210 which passes through side 110 of vehicle 100 to secure it to side 110.

Anchor piece 1212 has a hinge piece 1250 which connects air deflector 1100 to anchor piece 1212.

In this position, flexible snap clip 1214 of the angled arm 1216 attaches to anchor piece 1212 holding air deflector in this position.

Deflector mount 1230 of angled arm 1216 is shown here attached to air deflector 1100 with fasteners 1130.

In alternative embodiments of the present invention, angled arm 1216 may be attached to air deflector 1100 by any other known means of attachment.

In order to keep the air deflector 1100 light, yet strong, it is designed to have hollow spaces 1110 with intermediate ribs 1120.

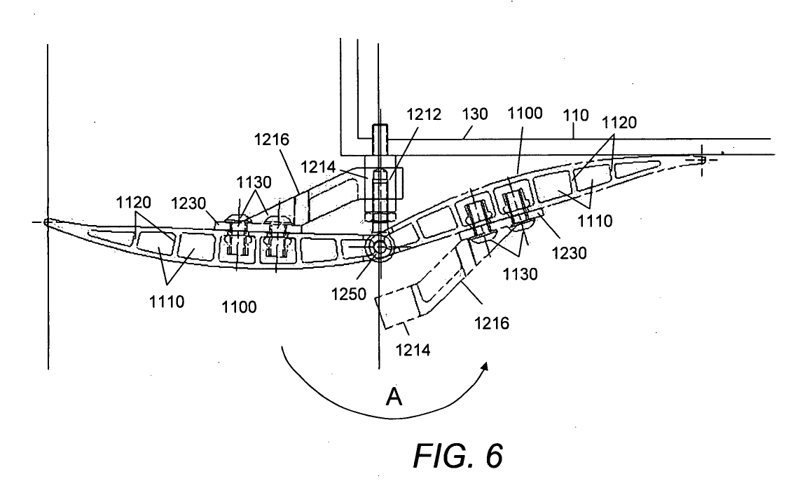

FIG. 6 is an enlarged cross sectional view of a portion of the present invention 1000 attached to the rear section 130 showing both the working and the unloading positions of the present invention.

All of the parts having the same number as the previous figure have the same function as described with reference to the previous figures.

The air deflector 1100 is shown in phantom pivoted around hinge 1250 into its unloading position. It is placed in this position prior to backing up the trailer 100 to the loading dock.

As is visible, flexible snap clip 1214 is pulled off of anchor piece 1212 allowing the entire structure to rotate in the direction marked “A”.

Angled arm 1216 remains fixed to air deflector 1100 with fasteners 1130 that attach the deflector mount 1230 to air deflector 1100.

The entire assembly pivots around hinge 1250 and out of the way allowing the vehicle to back up to and meet flush with the loading dock surface.

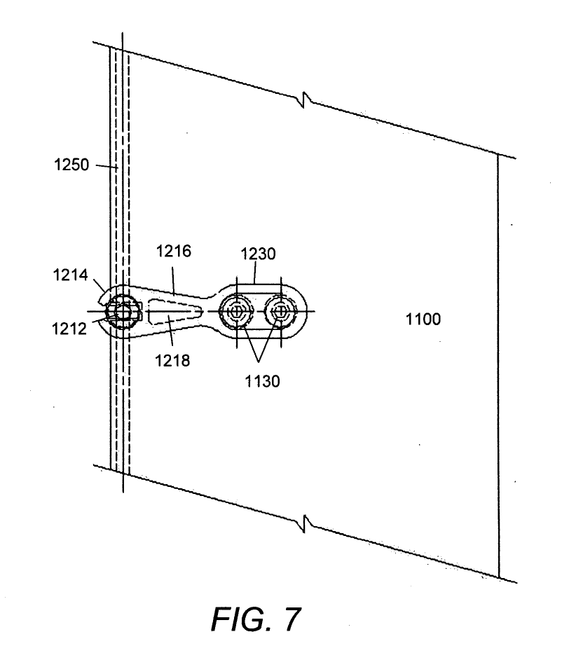

FIG. 7 is a partial elevational view from between the vehicle 100 and air deflector 1100 showing the flexible snap clip 1214 according to the present invention.

This is an enlarged image showing flexible snap clip 1214 attached to anchor piece 1212. Angled arm 1216 is shown with a hollowed section 1218 to reduce weight.

The deflector mount 1230 is shown here attached to air deflector 1100 with two fasteners 1130.

The entire structure, except the anchor piece 1212, is allowed to rotate about hinge 1250 when flexible snap clip 1214 is not attached to anchor piece 1212.

Other removable attachment means may also be used in place of anchor piece 1212 and flexible snap clip 1214 for holding air deflector 1100 in the working position when connected but allow the air deflector to pivot into the unloading position when not attached.

Such means may be any conventional mechanical removable attachment means including latches, locks, clips, snaps, connectors, and fittings. Other non-mechanical means may be used such as magnets, hook and loop, two-part material (similar to the connectors sold under the trademark Velcro®)), or other known fasteners.

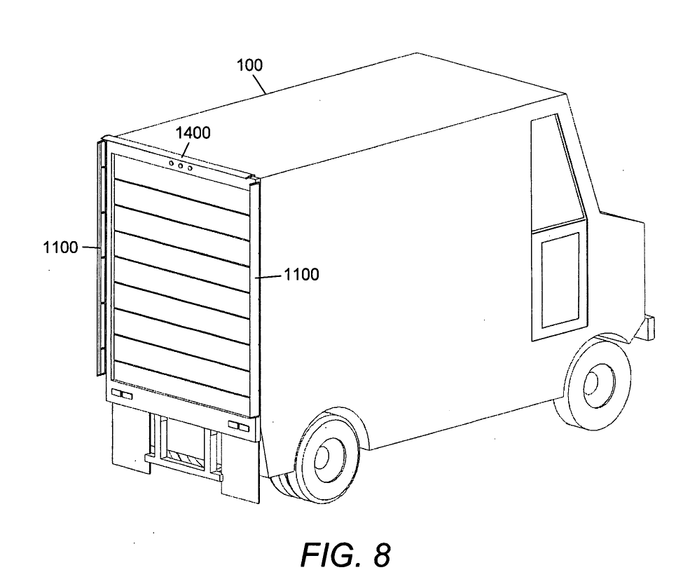

FIG. 8 is a partial perspective view of one embodiment of the drag reduction system 1000 according to the present invention as it would appear installed on a delivery truck 100.

In this alternative embodiment, the delivery truck does not have the barn-type doors on the rear.

A pair of air deflectors 1100 is attached on the sides 110 near the rear section 130.

As stated above, alternatively, a top deflector 1400 may be used.

Even though the present invention was described in connection with the side air deflectors 1100, they apply equally well to the top deflector 1400.

The present invention 1000 may also be employed in an embodiment which connects to the fixed portion of the rear of the vehicle 100. This may be the structure on the sides of a roll-up door or other fixed structure.

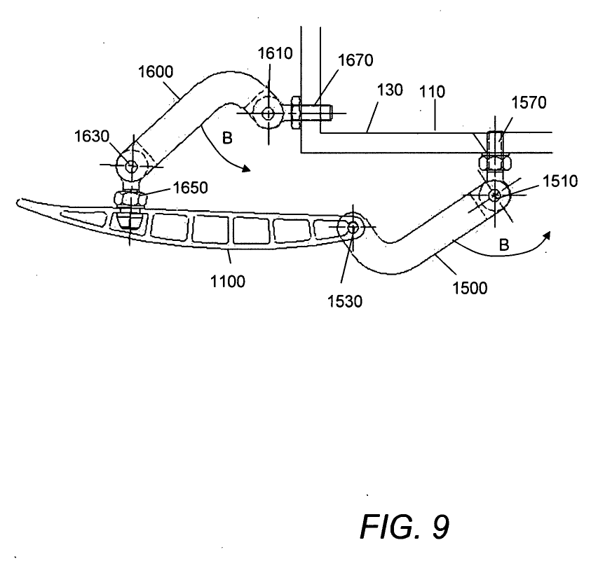

FIG. 9 is an enlarged cross sectional view of an alternative embodiment of the present invention in its driving position.

Here the air deflector 1100 is pivotally attached to the sides 110 of the rear section 130 of the vehicle. It employs a leading arm 1500 and a trailing arm 1600. A leading arm vehicle mount 1570 is attached to a side 110 of the vehicle. A first end of the leading arm 1500 is pivotally attached to the leading arm vehicle mount 1570 through a leading arm vehicle hinge 1510.

A second end of the leading arm 1500 is pivotally attached to the air deflector 1100 at a leading arm deflector hinge 1530.

Similarly, a trailing arm 1600 has a first end pivotally attached to a deflector mount 1650 through a trailing arm deflector hinge 1630. The deflector mount 1650 is attached to the air deflector 1100.

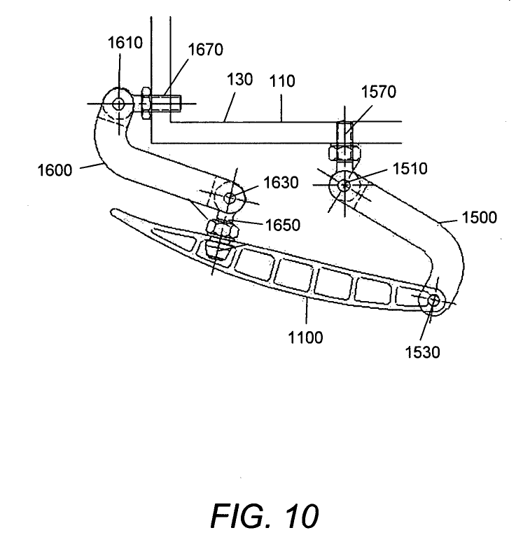

In FIGS. 9 and 10 the trailing arm vehicle mount 1670 is shown attached to the rear of the vehicle. However, in alternative embodiments, it may be attached to the sides 110.

A second end of the trailing arm 1600 is pivotally attached to the trailing arm vehicle mount 1670 through a trailing arm vehicle hinge 1610.

The leading arm 1500 and the trailing arm 1600 act to hold air deflector 1100 in driving position which extends past the rear of the vehicle and is angled to cause air to be deflected to a location behind the vehicle. The air deflector 1100 leading arm 1500, trailing arm 1600 and attached parts are intended to remain in this position as the vehicle is being driven. This deflects the air to a location behind the vehicle reducing air drag and increasing fuel economy.

The leading arm 1500, the trailing arm 1600 and air deflector 1100 are designed to pivot in the direction marked by the arrow marked “B” to move it to the unloading position.

FIG. 10 is an enlarged cross sectional view of an alternative embodiment of the present invention in its unloading position.

Here is shown that air deflector 1100 has translated forward to allow the rear section 130 of the vehicle to back up to a loading dock unhindered.

In this embodiment, trailing arm vehicle hinge 1610 extends slightly past the end of the vehicle. Since the perimeter of standard loading docks includes flexible seals that deform slightly, the present invention may be used with these loading docks.

In an alternative embodiment, the trailing arm vehicle mount 1670 is attached to the side 110 of the vehicle instead of its rear surface. The length of the trailing arm 1600 may be changed to compensate for the different mounting position. This embodiment also may be used and translated forward during loading to be compatible with existing loading docks.

Also, the present invention is applicable to other large vehicles that do not employ barn-type rear doors.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. An air drag reduction system [1000] for increasing the fuel efficiency of a vehicle [100] having a rear section [130] at least one generally planar, side, surface [110] and an air stream passing along the rear surface [130], comprising:
a) an air deflector [1100] at least partially extending past said rear section [130] of said vehicle [100] for deflecting said air stream at an angle behind said vehicle [100],
b) a hinged attachment piece [1200] connected to said vehicle [100] and to said air deflector [1100] allowing the air deflector to pivot to a first position extending past said rear section [130] of said vehicle [100] in which it deflects said air stream behind the vehicle [100], and a second position in which the air deflector [1200] and hinged attachment piece [1200] pivot forward and do not extend beyond an end of said rear section [130] of said vehicle [100] allowing said vehicle [100] to fit against a standard loading dock.

2. The air drag reduction system [1000] of claim 1, wherein the air deflector [1100] is elongated, extending a major portion of said vehicle's [100] height.

3. The air drag reduction system [1000] of claim 1, wherein the hinged attachment piece [1200] comprises:
a) a vehicle mount [1210] which attaches to said vehicle [100];
b) a deflector mount [1230] which is connected to the air deflector [1100]; and
c) a hinge [1250] which pivotally connects the vehicle mount [1210] to the deflector mount [1230], allowing the deflector mount [1230] to be placed in the first position or the second position.

4. The air drag reduction system [1000] of claim 3, wherein the hinged attachment piece [1200] further comprises:
a) a first connector [1211] which is attached to the vehicle mount [1210];
b) a second connector [1231] attached to the deflector mount [1230] adapted to be removeably attached to the first connector [1211] to hold the deflector mount [1230] and the air deflector [1100] in the first position, thereby deflecting said air stream at an angle behind the vehicle [100].

5. The drag reduction system [1000] of claim 1, wherein the first and second connectors [1211. 1231] comprise:
a) an anchor piece [1212]; and
b) a flexible snap clip [1214] which removeably attaches to said anchor piece.

6. The air drag reduction system [1000] of claim 1, wherein the first and second connectors comprise:
hook and loop attachment material.

7. The air drag reduction system [1000] of claim 1, wherein the first and second connectors comprise: snaps.

8. The air drag reduction system [1000] of claim 3 wherein the vehicle mount [1210] is designed to retrofit existing vehicles [100].

9. The drag reduction system [1000] of claim 3 wherein the vehicle mount [1210] is designed to be a part of a newly manufactured vehicle [100].

10. The air drag reduction system [1000] of claim 3 wherein the deflector mount [1230] is manufactured as part of the air deflector [1100].

11. A method of reducing air drag and increasing fuel economy of a moving vehicle [100] having a rear section [130] which is compatible with existing loading docks, comprising the steps of:
a) pivotally securing an air deflector [1100] to extend from the rear of said vehicle [100] in a first position angled to direct said air stream to a location behind said vehicle [100] when said vehicle is being driven; and
b) pivoting the air deflectors [1100] to a second position so that they do not extend beyond the rear section [130] of said vehicle [100] when being docked to allow said vehicle rear section [130] to mate with a conventional loading dock.

12. The method of claim 11 further comprising the step of employing a first connector [1211] to connect to a second connector [1231] to hold the air deflector [1100] in its first position.

13. The method of claim 12 further comprising the step of disconnecting first connector [1211] from the second connector [1231] to allow the air deflector [1100] to pivot so that it does not extend beyond said rear section [130].

14. The method of claim 12 wherein the step of employing a first connector [1211] and a second connector [1231] comprises the step of:
employing an anchor piece [1212] as the first connector [1211] and a flexible snap clip [1214] which removeably attaches to said anchor piece [1212] as the second connector [1231] to hold the air deflector [1100] in its first position.

15. The method of claim 12 wherein the step of employing a first connector [1211] and a second connector [1231] comprises the step of:
employing a first hook and loop attachment material as the first connector [1211] and a second hook and loop attachment material which is capable of removeably attaching to the first hook and loop material as the second connector [1231] which attach to each other to hold the air deflector [1100] in its first position.

16. The method of claim 12 wherein the step of employing a first connector [1211] and a second connector [1231] comprises the step of:
employing a first snap part as the first connector [1211] and a second snap part which is adapted to removeably attach to the first snap part as the second connector [1231] which attach to each other to hold the air deflector [1100] in its first position.

17. An air drag reduction system [1000] for increasing the fuel efficiency of a vehicle [100] having a rear section [130] at least one generally planar, side, surface [110] and an air stream passing along the rear surface [130], comprising:
a) an air deflector [1100] having a leading edge and a trailing edge, at least partially extending past said rear section [130] of said vehicle [100] for deflecting said air stream at an angle behind said vehicle [100];
b) a leading arm [1500] having a first end pivotally connected to said vehicle [100] and a second end pivotally connected to the leading edge of the air deflector [1100]; and
c) a trailing arm [1600] having a first end pivotally connected to said vehicle [100] and a second end pivotally connected to the trailing edge of the air deflector [1100].

18. The air drag reduction system [1000] of claim 17, further comprising a leading arm vehicle hinge [1510] to pivotally connect the leading arm [1500] to the vehicle [100];

19. The air drag reduction system [1000] of claim 17, further comprising a leading arm deflector hinge [1530] to pivotally connect the leading arm [1500] to the air deflector [1100].

20. The air drag reduction system [1000] of claim 17, further comprising a trailing arm vehicle hinge [1610] to pivotally connect the trailing arm [1600] to the vehicle [100];

21. The air drag reduction system [1000] of claim 17, further comprising a trailing arm deflector hinge [1630] to pivotally connect the trailing arm [1600] to the air deflector [1100].
